(19) United States
(12) Patent Application Publication
(10) Pub. No.: US 2018/0263424 A1
(43) Pub. Date: Sep. 20, 2018

(54) Eze chef is a device,a transparent thinwall plastic sheath, that when placed over a clear transparent plastic botte will measure ingredient levels to insure perfect recipe presentations of finished food entrees

(71) Applicant: Dennis Lee Kjenner, Byron, IL (US)

(72) Inventor: Dennis Lee Kjenner, Byron, IL (US)

(73) Assignee: Dennis L Kjenner

(21) Appl. No.: 15/530,892

(22) Filed: Mar. 17, 2017

(51) Int. Cl. A47J 43/27; B01F 13/00; B01F 15/00

(52) U.S. Cl. CPC A47J 43/27; B01F 13/0022; B01F 15/00512; B01F 15/00857; B01F 15/00155

(57) ABSTRACT

EZE CHEF is a device a transparent plastic sheath that when placed over a bottle will measure ingredient levels to insure perfect recipe presentations of finished food entrees is disclosed. My invention improves on others by allowing a user to change the size of the mixing vessel without changing the ratio between ingredients and still come out with the same perfect end result.

### FIELD OF THE DISCLOSURE

The present disclosure relates generally to the field of mixing containers mixing vessels and alternate uses for kitchen gadgets, also relates to a less complicated method of preparing chef quality recipes for home use in the homemakers own kitchen. More particularly the present disclosure relates to an improved method for achieving chef quality entrees for home use in the simplest way possible. A child at age 14 can prepare his own breakfast in the simplest way.

### Background

When homemakers prepare medium to complex recipes at home there are too many things to do in a short time to produce a good finished food entrée, too many directions to follow and too many measurements to remember and too many mixing bowls and kitchen gadgets to wash, also many recipes are too large for one or two people.

### DESCRIPTION OF RELATED ART

Users can use this device and method to produce superior sensitivity and essence that only certified chefs are accustomed to. Other devices lack the diversity and the ability to provide solutions to problems of complexity.

My invention improves on others by allowing a user to change the size of the mixing vessel without changing the ratio between ingredients and still come out with the same perfect end results.

Therefore, there is a need for a simple yet effective device and method for preparing chef quality food presentations and entrees at home.

The present disclosure solves many of the problems of conventional cooking methods such as time consumption, too many directions to follow and too many measurements to remember, and too many mixing bowls and kitchen gadgets to wash. The invention claimed here solves these problems.

The present embodiment of this kit invention will solve the problem of time consumption caused by paragraphs of direction and instruction. The user doesn't need mixing bowls, measuring cups or measuring spoons, no need for an electric stand mixer, user will not need a wet bowl or a dry bowl. The user will not need a long complex recipe to follow. User will be able to store invention in the refrigerator, and user will not have a sink full of dirty dishes to wash, also user will not have to remember measurements.

The claimed invention differs from what currently exists. This invention is an improvement, is better than and different from any prior art. This invention enables the user to create perfect food entrees of five Star restaurant chefs at home. This invention provides the methods as well as the knowledge of famous chefs in one easy step. This invention provides a method used by famous chefs worldwide.

### SUMMARY OF PREFERRED EMBODIMENT OF THE DISCLOSURE

Advantages of One or More Embodiments of the Present Disclosure

This kit package could contain coupons for marketing consumer products such as ingredients used in the formulation of the recipes.

### HOW TO USE THE INVENTION

This invention makes preparing complex recipes easy as shaking and mixing, no complicated formula to follow, so easy a kid can do it, my 14 Yr. old grandson can make his own breakfast. It's that easy, also it can create superior finished food products in the simplest way possible.

### BRIEF DESCRIPTION OF THE DRAWINGS

FIG. 1 is substantially a front perspective view of the preferred embodiment of the present invention. Plastic Sleeve.

FIG. 2 is substantially a top perspective and full plan view of the preferred embodiment of the present invention. Spring shaped wire mixing ball.

FIG. 3 is substantially a front perspective and full plan view of the preferred embodiment of the present invention. A food grade plastic bottle with a capacity of 22 to 30 Ounces with flip top and ½″ or larger pour spout and unscrew top.

Although the descriptions above contain many specifications, these should not be construed as limiting the scope of the invention but as merely providing illustrations of some of the embodiments of this invention. Thus, the scope of the invention should be determined by the appended claims and their legal equivalents rather than by the examples given.

The above descriptions of the preferred embodiment should not be construed to limit the scope or intent of the present invention. The present invention is very diversified and can produce exceptional results, in finished food entrees. To name a few, this invention can produce but is not limited to and should not be construed to limit the scope and intention of this invention, to produce the following food entrees: Swedish pancakes, Buttermilk pancakes, Funnel cakes, cupcakes flavored puddings, heavy whipping cream. Scrambled eggs, Omelets customized salad dressings, customized barbeque sauces, drizzle icings for cakes cheese cake batter. and Cornbread batter, and more.

### CROSS REFERENCE TO RELATED APPLICATION

This is a divisional (or continuation-in-part, as appropriate) application of application Ser. No. 15/530,892 filed Mar. 17, 2017 or 371 (c) date and #62311730 Provisional application filed and Received by Commissioner for patents Mar. 17, 2017 USPTO Mail center. And relates to Formalities letter and confirmation No. #6356 mailed from USPTO on Mar. 29, 2017. This document claims benefit of earlier filing date of Provisional application. Filed by inventor Dennis Lee Kjenner of 547 E. Blackhawk Dr. Byron Illinois and Deborah Kay Kjenner of 547 E. Blackhawk Dr. Byron Illinois 61010 U.S.A.

The present embodiment of this invention is an improvement on what currently exists. This invention is an improvement, is better than and different from any prior art. This invention enables the user to create perfect food entrees of Five Star restaurant chefs at home. This invention provides the methods as well as the knowledge of famous chefs in one easy step. This invention provides a method used by famous chefs worldwide.

Other devices do not work well because they don't have the diversity, and the ease of use, the only thing they do is hold water. They don't provide solutions to problems.

My invention improves on others by allowing a user to change the size of the mixing vessel without changing the ratio between the ingredients and still come out with the same perfect end results, also it can produce superior finished food products in the simplest way possible.

### DETAILED DESCRIPTION OF THE INVENTION

### Relationship Between the Components

The relationship between the components are as follows. #1 component this cylinder shaped hollow tube has the recipe printed on it with markings for each ingredient in the recipe and the level at which to stop adding that ingredient. Component #2 is a food grade stainless steel, globe shaped spring shaped device which is placed inside the bottle, and used to incorporate air into the food mixture, and for effective mixing of recipe ingredients by shaking the bottle, back and forth rapidly. Component #3 The three bottles, each colored bottle has a specific use according to which recipe the user is preparing. Red for very light batters, blue for medium mixes such as omelet mixes, and green for heaver batters like buttermilk pancakes and chocolate pudding mixes. Component #4 the kit contains 6 printed recipes on 3 thin wall plastic sleeves. Component #5 consists of one packet of proprietary ingredients and spices. Component #6 consists of a cardboard packaging box with a window for viewing contents and graphics printing. Component #7 includes 3 bottles with logo printed on them.

### How the Invention Works

This invention does enable “One of ordinary skill in the art” to make and use this invention. Even a kid can do it. The invention components work to produce the best results by first.

1. Unpacking all components from packaging. 2. In your prep kitchen or counter top, place component number 3 “bottle” on counter and unscrew the top. 3. Ensure component number 2 globe shaped stainless steel spring, agitation devices are in the bottles. 4. Place transparent thin wall cylinder shaped sleeve with recipe on over/covering component #3 Bottle.

5. Beginning from the bottom, pour, put, or add, recipe ingredients in order, into the bottle until last ingredient is placed in bottle. Next remove plastic sleeve and replace cover onto bottle and tighten. Shake vigorously back and forth for about one minute, for most recipes.

6. After mixing, loosen pour cap and carefully pour ingredients onto hot cooking surface, Griddle, or pan do not overcook and turn over when necessary.

7. Each bottle will prepare an entrée for 1 to 3 people, depending on portion size.

### How to Make the Invention

This is a kit invention that is comprised partly from already existing parts. This application does not claim the invention of the individual parts or the construction there of. This inventor does claim to have originated a new and unique use of the kit components to produce chef quality food entrees at home by the end user, additionally the means disclosed herein consists of the above-listed steps.

All of the components and elements are necessary in the invention. Each one is useful in producing positive end results. Each component is useless by itself but work well in combination with each other. There are no optional components.

The various embodiments of the present invention may, but do not necessarily, achieve one or more of the following advantages:

The ability to measure ingredient levels to insure perfect recipe presentations of finished food entrees.

This invention provides the methods as well as the knowledge of famous chefs in one easy step.

This invention enables the user to create perfect food entrees of Five Star restaurant chefs at home.

The present embodiment of this kit invention will solve the problem of time consumption caused by paragraphs of direction and instruction.

The end user of the present embodiment of this invention will not need a wet bowl, or a dry bowl. The user will not have to follow a long complex recipe to achieve perfect recipe presentations of finished food entrees.

The user of this invention will not need mixing bowls, measuring cups or measuring spoons, no need for an electric stand mixer.

The present embodiment of this invention will enable user to store invention in the refrigerator.

The user will not need a long complex recipe to follow.

After using this invention the user will not have to wash a sink full of dirty dishes.

This invention provides a method used by famous chefs worldwide.

This invention provides the diversity, and the ease of use to solve many of the problems mentioned above.

My invention improves on others by allowing a user to change the size of the mixing vessel without changing the ratio between ingredients and still come out with the same perfect end results.

This invention can produce superior finished food products in the simplest way possible.

### BRIEF DESCRIPTION OF PREFERRED EMBODIMENT OF THE PRESENT DISCLOSURE

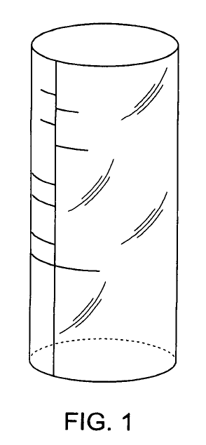

In preferred embodiment, the present invention comprises a plurality of components first of which is a hollow thin wall transparent plastic sleeve cylinder shaped, printed with a recipe on the front side and back side in white food safe ink. The size of which is 2¾″ wide×8½″ High. This is illustrated by drawing labeled FIG. 1.

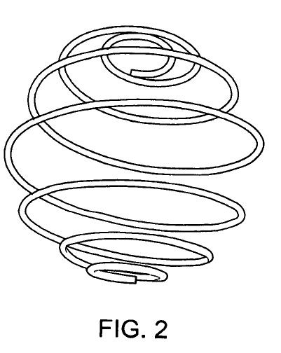

The second component of the present invention comprises a device for incorporating air into foods, made of food grade stainless steel and being globe shaped, spring like in structure, and commonly called a shaker ball this shaker ball is about the size of a standard golf ball, or larger, and is illustrated by drawing labeled FIG. 2. There are 3 one for each bottle.

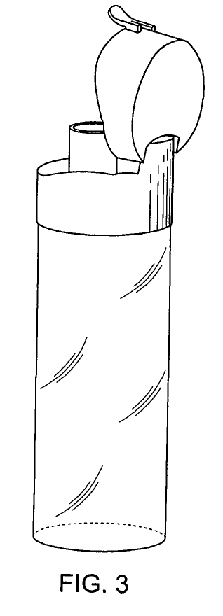

The third component of the present invention comprises/consists of a food grade plastic bottle with a 22 to 30 Ounce capacity with a removable screw on cover and a ½″ or larger pour spout. Bottle is made of transparent food grade plastic with a tint color of light green, light blue, and light red. Each one printed according to the function it performs in the recipe. Dimensions of the bottle are 2½″ to 2¾″ wide. This is illustrated by drawing labeled FIG. 3.

Component number 4 consists of 6 printed recipes on 3 plastic sleeves, illustration drawing FIG. 4.

1. The device of claim 1, is comprised of a transparent plastic sleeve cylinder printed, the size of which is 2¾″ wide×8½″ high, and is the first and major component of this device, and is constructed of food grade thin wall plastic. DRAWING FIG. 1

2. The device of claim 1, is comprised of and includes a food grade stainless steel, globe shaped, wire ball for mixing ingredients and incorporating air into the food mixture, for superior finished results. DRAWING FIG. 2.

3. The device of claim 1, is comprised of and includes component #3 a food grade plastic bottle with a 22 to 30 Ounce capacity, with a removable screw on cover and a ½″ or larger pour spout, being made of transparent plastic with a tint color of light green, light blue, or light red, of which the dimensions of the bottles being 2½″ to 2¾″ wide×8½″ high. DRAWING FIG. 3.

4. The device of claim 1. Is comprised of and includes component #4 consisting of 6 Printed recipes on 3 plastic sleeves.

5. The device of claim 1, is comprised of and includes component #5 consisting of a packet of proprietary ingredients and spices.

6. The device of claim 1. Is comprised of and includes component #6 consisting of a cardboard packaging box, or plastic packaging with a transparent plastic window and graphics printing.

7. The device of claim 1. Is comprised of and includes component #7 consisting of 3 shaker bottles having logo printed on them, and the one colored pink, label will read, (SHAKE EZE SQUEEZE EZE), a blue bottle reading, (MAKE EZE SQUEEZE EZE), and a green bottle reading, (EZE SQUEEZE EZE).

8. The device of claim 1, herein described as three bottle logos are intended to be used as registered trademarks belonging to Dennis Lee Kjenner and Deborah Kay Kjenner of Byron Illinois 61010 U.S.A.
